(19) United States
(12) Patent Application Publication
(10) Pub. No.: US 2008/0130980 A1
(43) Pub. Date: Jun. 5, 2008

(54) Paper currency note scanner and identifier for use by visually impaired individuals

(76) Inventors: Mary E. Gildersleeve, Brick, NJ (US); Stephen Frayne, Humble, TX (US)

Correspondence Address: CLIFFORD G. FRAYNE, 136 DRUM POINT RD, SUITE 7A, BRICK, NJ, 08723, US

(21) Appl. No.: 11/986,798

(22) Filed: Nov. 28, 2007

Related U.S. Application Data
(60) Provisional application No. 60/872,735, filed on Dec. 4, 2006.

(51) Int. Cl. G06K 9/00

(52) U.S. Cl. 382/135

(57) ABSTRACT

A miniature hand held scanner easily transportable on a key ring or pocket, the scanner having a computer chip positioned therein, the computer chip having stored thereon indicia peculiar to each paper currency note denomination, the scanner capable of scanning a portion of a paper currency note presented to an individual, comparing the indicia scanned to the indicia stored on the chip and the scanner having an audio capability to announce the denomination of the paper currency note scanned such that a visually impaired person can be assured that they are being provided with the correct change or monies due.

### RELATED APPLICATIONS

Applicant claims the benefit of provisional application Ser. No. 60/872,735, filed Dec. 4, 2006.

### BACKGROUND OF THE INVENTION

1. Field of the Invention

The present invention relates to a scanner assembly with indicia recognition software and audio which is miniaturized and hand held, and which can be utilized to scan indicia on a portion of a currency bill and to audibly identify the denomination of the scanned bill for the benefit of a visually impaired individual.

2. Description of the Prior Art

At the present time paper currency in the United States is all of the same size, but of different denominations. In other jurisdictions in the world, the paper currency is oftentimes differently sized depending upon the denomination.

At the present time there are approximately one million visually impaired individuals in the United States who can identify the denomination of coins because of their size and shape, and their sense of touch and feel is keenly developed to enable them to discern between the texture of paper currency and ordinary paper, but they have difficulty in determining the denomination of paper currency. This does not present a problem when they are in the accompaniment of a friend or relative, however, when they are alone and are receiving paper currency from a vendor, it is difficult if not impossible for them to determine whether or not they are being provided with the correct paper currency change.

The courts of the United States have recently determined that it is discrimination of the visually impaired that the United States Mint prints its paper currency of the same size, and the courts have suggested if not mandated that the U.S. Treasury implement procedures that would require the changing of the size of paper currency denominations in the United States so that one could determine the denomination of a particular note by its size. It is estimated that the cost of such a makeover would cost in the name of 250 to 500 million dollars, not to mention that current vending machines, ATM's and cash register tills would become immediately obsolete.

Applicant's solution would not require such a makeover, and would allow visually impaired individuals to carry a readily available scanner in which an indicia of various paper currencies have been stored, and which can be compared to the indicia on paper currency being provided to the visually impaired person through a quick scan with the scanner having audio capabilities to announce the denomination of the paper currency which the visually impaired person has just scanned.

### OBJECTS OF THE INVENTION

An object of the invention is to provide for a novel miniature hand held scanner having identifying indicia of paper currency stored therein and comparable to the indicia of paper currency scanned with an audio capability to announce the denomination of the paper currency notes scanned to an individual, and in particular, to a visually impaired person.

### SUMMARY OF THE INVENTION

A miniature hand held scanner easily transportable on a key ring or pocket, the scanner having a computer chip positioned therein, the computer chip having stored thereon indicia peculiar to each paper currency note denomination, the scanner capable of scanning a portion of a paper currency note presented to an individual, comparing the indicia scanned to the indicia stored on the chip and the scanner having an audio capability to announce the denomination of the paper currency note scanned such that a visually impaired person can be assured that they are being provided with the correct change or monies due.

### BRIEF DESCRIPTION OF THE DRAWINGS

These and other objects of the present invention will become apparent, particularly when taken in light of the following illustrations wherein:

FIG. 1 is a planar view of a typical currency note identifying various peculiar indicia which could be stored on the scanner for comparison;

FIG. 2 is a perspective view of the scanner/identifier;

FIG. 3 is a schematic of the phase input response function for optical character recognition;

FIG. 4 is a schematic example of hardware implementation of a phase input response function algorithm; and

FIG. 5 is a block diagram of a dynamically reconfigurable phase input response function.

### DETAILED DESCRIPTION OF THE INVENTION

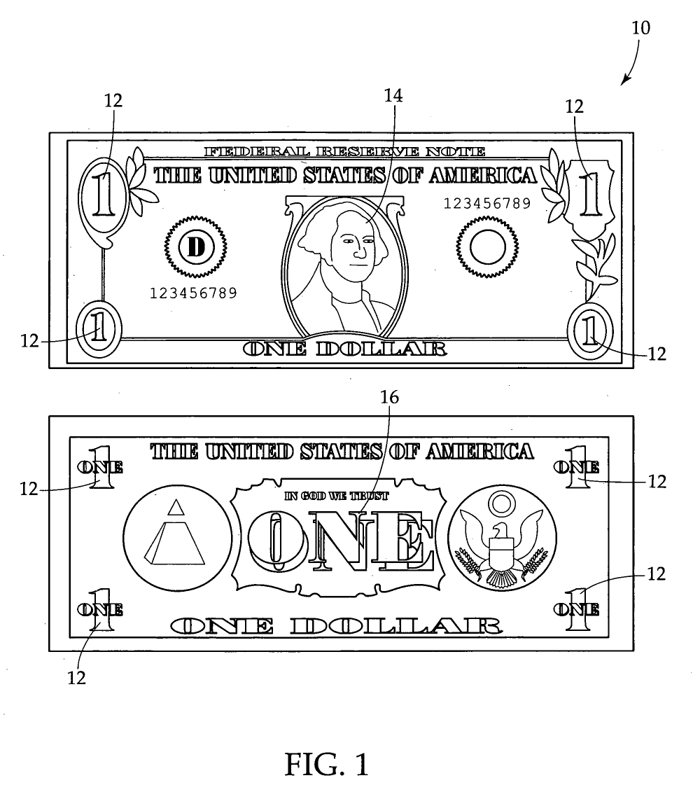

FIG. 1 is a planar view of a typical currency note illustrating the front face and rear face of a one dollar bill 10. The one dollar bill currency note 10 has a variety of indicia specific to it which could be scanned for identification. For instance, the upper or lower corners where the denomination of the note 12 is identified could be scanned to identify the denomination of the note. Still further the portrait figure indicia 14 appearing on the front face of the currency bill 10 could be scanned to identify the note since all U.S. currency note denominations have a different portrait figure indicia 14 for each denomination. Finally, the central portion of the rear face 16 could be scanned where once again the denomination of the paper currency note 10 is identified. The foregoing indicia are not all encompassing of the indicia which could be scanned, but represent the most obvious and easily scanned indicia for a paper currency note.

Since the most common paper currency notes in circulation are the one dollar bill, the five dollar bill, the ten dollar bill, the twenty dollar bill, the fifty dollar bill, and the one hundred dollar bill, these would be the paper currency notes the indicia of which would be stored or embedded in a memory chip in the scanner for either optical character recognition or template matching cross correlation matching.

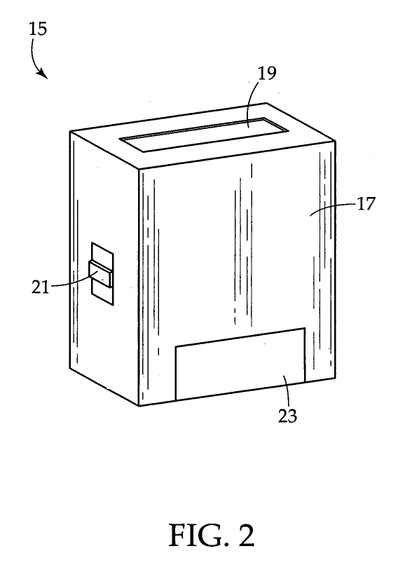

FIG. 2 is a perspective view of the portable scanner identifier 15 having a housing 17 and scanning element or slit 19. The housing 17 would have an on/off selector 21 coupler to a power source removably replaceable within power compartment 23.

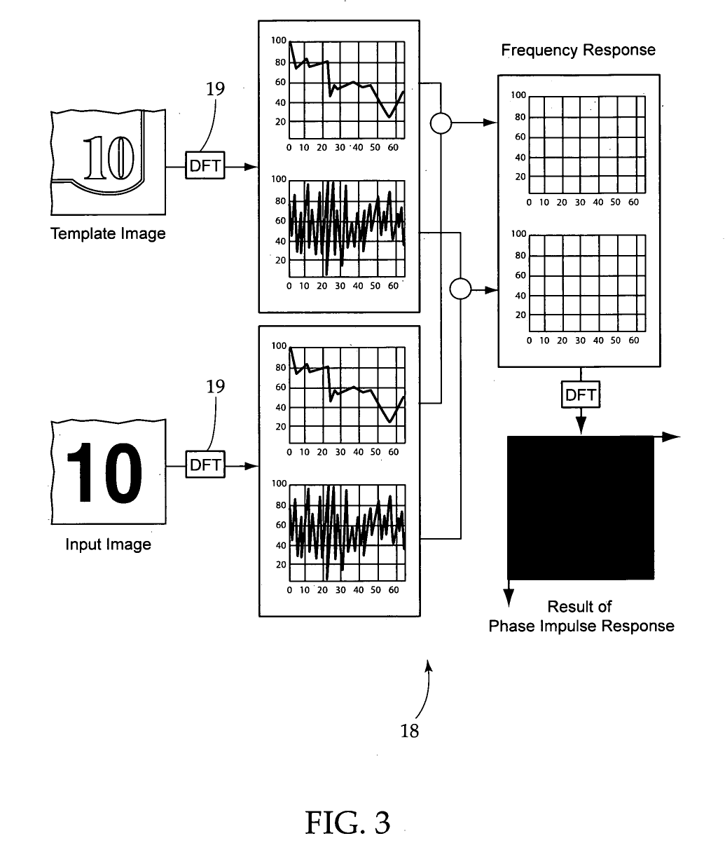

The implementation of the scanner would consist of three primary elements positioned within a housing 17. FIG. 3 represents the optical character recognition function 18 in which the scanning element or slit 19 would be drawn across one of the indicia identified in FIG. 1. An optical character recognition (OCR) embedded ASIC using either phase input response function (PIRF) or equally common template-matching cross correlation methods would be utilized to match the indicia scanned to the indicia stored in the scanner.

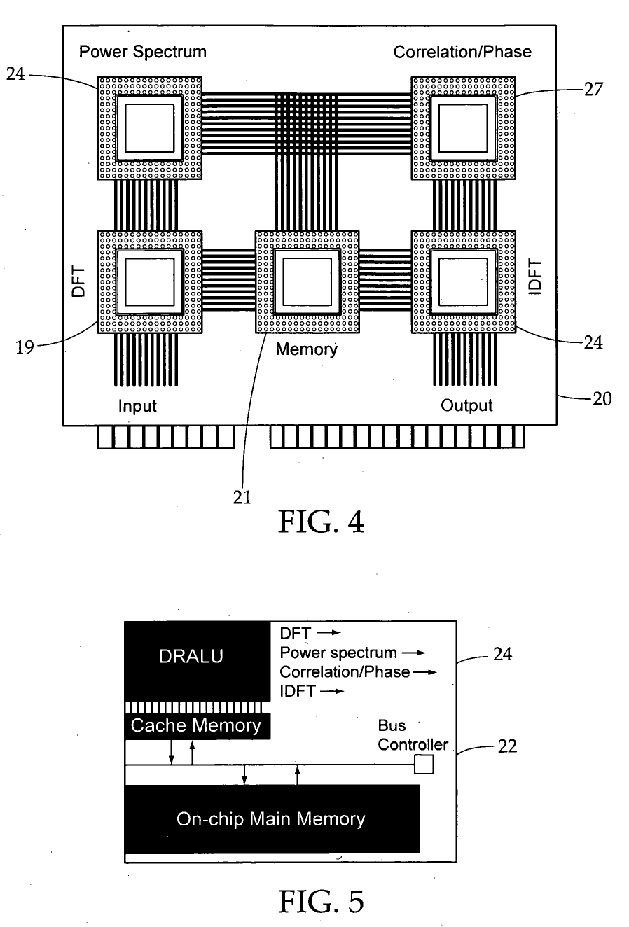

FIG. 4 is an example of the hardware implementation of a PIRF algorithm on a PCB mini card. A dynamically reconfigurable processor 20 is utilized so that the processor can be dynamically reconfigurable in order to insure upgradeability to changes in money supply over time. However, if two unique characteristics of the money supply remain constant over time, the reconfigurability feature may not be necessary. The paper currency indicia would be stored in memory 21. The scanned portion of a paper currency bill 10 would be inputted via input and scanning slit 19. Comparison and matching would be accomplished by correlation 27 and an output signal would be generated.

FIG. 5 is an output human interface device 22 schematic (HID) to relay signals to visually impaired users. While any device which outputs in the form of touch, taste, smell and sound would be satisfactory to a visually impaired user, due to limited availability of touch, taste, and smell output devices would dictate the use of a sound output in the form of a simple frequency-band-limited audio modulation device (speaker) 24, a commonly available 300 ohm telephone speaker would suffice in order to relay the simple information “one dollar”, “five dollars”, “ten dollars”, “twenty dollars”, “fifty dollars”, and “one hundred dollars” at a suitable amplification level.

Coupled with a simple energy storage device 26 such as a single AA battery, this configuration should ensure that users can turn visual information of the scanned currency they are carrying or receiving into audible information such that any visually impaired individual can understand and comprehend.

Battery life may also be maximized with a manual or automatic on/off switch. Since only a portion of the paper currency note requires scanning, the scanning slit does not have to be excessive such that the entire apparatus would be approximately the size of a small cell phone.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

We claim:

1. A portable paper currency note scanner and identifier for the visually impaired comprising:
a housing member having a scanning slit dimensioned to scan a selected indicia of a paper currency note and to temporarily input said selected indicia of said scanned portion of said paper currency note;
a memory chip positioned in said housing member, said memory chip embedded with selected indicia of said paper currency notes;
an optical character recognition member positioned in said housing comparing said scanned indicia to said imbedded selected indicia on said memory chip;
an output interface outputting a signal identifying the denomination of the paper currency note scanned.

2. A portable paper currency note scanner and identifier for the visually impaired in accordance with claim 1, wherein selected indicia scanned and said selected indicia embedded in said memory chip comprise the corners of said paper currency notes identifying said denomination.

3. The portable paper currency note scanner and identifier for the visually impaired in accordance with claim 2, wherein said signal identifying said denomination of said paper currency note is an audio identifying message of said denomination of said paper currency note based upon said scanned currency denomination.

4. A portable paper currency note scanner and identifier for the visually impaired in accordance with claim 1, wherein said selected indicia scanned and said selected indicia embedded in said memory chip comprises a portrait figure imposed on a face of said paper currency note.

5. The portable paper currency note scanner and identifier for the visually impaired in accordance with claim 4, wherein said signal identifying said denomination of said paper currency note is an audio identifying message of said denomination of said paper currency note based upon identification of said portrait figure.
